(19) United States
(12) Patent Application Publication
(10) Pub. No.: US 2024/0133845 A1
(43) Pub. Date: Apr. 25, 2024

(54) METHOD FOR DETECTING NATURAL FREQUENCY OF BLADE BY SINGLE BLADE TIP TIMING SENSOR

(71) Applicant: XI'AN JIAOTONG UNIVERSITY, XI'AN (CN)

(72) Inventors: Zhibo YANG, Xi'an (CN); Jiahui CAO, Xi'an (CN); Haoqi LI, Xi'an (CN); Shaohua TIAN, Xi'an (CN); Laihao YANG, Xi'an (CN); Zengkun WANG, Xi'an (CN); Xuefeng CHEN, Xi'an (CN); Shuming WU, Xi'an (CN)

(21) Appl. No.: 17/971,429

(22) Filed: Oct. 20, 2022

(51) Int. Cl. G01N 29/12; G06F 17/14; G06F 17/16

(52) U.S. Cl. CPC G01N 29/12; G06F 17/14; G06F 17/16

(57) ABSTRACT

The present disclosure discloses a method for detecting a natural frequency of a blade by a single blade tip timing sensor. In the method, two segments of displacement data vectors are subjected to dot product to obtain a product data vector after multiplication of corresponding serial numbers, the product data vector is subjected to low-frequency filtering, the filtered product vector is subjected to Hilbert transform to obtain an instantaneous phase, the instantaneous phase is subjected to discrete Fourier transform, an absolute value of a natural frequency difference between blades is extracted from amplitude frequency data, blades on a bladed disk are subjected to permutation and combination to obtain absolute values of the natural frequency differences between all the blades, a sum of the absolute values of the natural frequency differences between each blade and other blades is calculated.

### FIELD

The present disclosure belongs to the field of non-contact non-destructive detection of blades, and particularly relates to a method for detecting a natural frequency of a blade by a single blade tip timing sensor.

### BACKGROUND

Large-scale heat engines, represented by gas turbines and aeroengines, are national key machines with high reliability requirements and extremely complicated technology. The blade is one of the key parts with the most accidents in these large turbine machines. The performance of the blade directly affects the safety and stability of the aero engines, gas turbines and other devices. Therefore, it is an inevitable trend to ensure the safe operation of high-speed rotating blades and realize real-time online monitoring of blade vibration. Blade cracks, fractures and other damage faults are mostly caused by faults. To ensure the safe operation of rotating machine, higher requirements are put forward for the vibration measurement of the rotating blade. The vibration measurement method of the rotating machine may be divided into contact measurement and non-contact measurement. The contact measurement is a method for acquiring measurement information by direct contact between a sensor and a rotating blade, which has low reliability, short service life and a complicated and time-consuming safety method. The non-contact measurement refers to a measurement method in which a sensor is not in contact with a blade, and can achieve the aim of accurate measurement on the premise of not affecting the operation state of the blade and overcome the disadvantages of the contact measurement. The non-contact rotating blade vibration measurement technology based on a blade tip timing principle has attracted a large number of researchers' attention due to the advantages of simple structure, fast response, small volume and capability of monitoring the vibration of a plurality of blades at the same time. Blade tip timing (BTT) is a method for performing non-contact online measurement on the vibration of a rotating blade, wherein a blade tip timing sensor is radially mounted on a stationary casing of the rotating machine, and the sensor is used to receive a pulse signal which is generated by the rotating blade and passes the front of the sensor so as to record arrival time of the blade. A blade tip timing sampling rate is related to a rotational speed and a number of the sensors, due to the limited mounting position of the sensor in actual situations, blade tip timing data has an excessive undersampling characteristic, and even a rotational speed sensor cannot be mounted. The blade tip displacement measurement with a rotational speed reference method needs to convert an arrival time difference of the blade into blade tip displacement by virtue of the rotational speed. Furthermore, in an actual use, a plurality of blade tip timing sensors are often selected to be used to alleviate the aliasing influence caused by undersampling, but the installation of the rotational speed sensor and the plurality of blade tip timing sensors in the actually limited space will cause great trouble and increase the measurement cost. Traditional methods mostly involve a large number of operations when performing modal parameter identification on uniformly distributed and non-uniformly distributed data of the blade tip timing sensors, so that online real-time detection and diagnosis cannot be realized. In addition, most algorithms directly identify the natural frequency and other parameters of a single blade, resulting in a large error. These are the important reasons why the blade tip timing technology cannot be applied to important devices.

The above information disclosed in the background segment is only used to enhance the understanding of the background of the present disclosure, and therefore may include information which does not constitute the prior art well known to those of ordinary skill in the art in China.

### SUMMARY

For the problems in the prior art, the present disclosure provides a method for detecting a natural frequency of a blade by a single blade tip timing sensor, thereby evaluating the health state of the blade more rapidly and accurately.

An objective of the present disclosure is achieved by the following technical solution. A method for detecting a natural frequency of a blade by a single blade tip timing sensor includes the following steps:
a first step: acquiring actual arrival time of a rotating blade by using a single blade tip timing sensor, and converting a difference between theoretical arrival time and the actual arrival time into displacement data of a blade tip according to a rotational speed and a blade length of the rotating blade;
a second step: intercepting two segments of displacement data vectors of two blades at the same rotational speed from the displacement data;
a third step: performing dot product on the two segments of displacement data vectors to obtain a product data vector, and performing low-frequency filtering on the product data vector;
a fourth step: performing Hilbert transform on the filtered product vector to obtain an instantaneous phase, performing discrete Fourier transform on the instantaneous phase, and extracting an absolute value of a natural frequency difference between blades from amplitude frequency data, wherein a frequency corresponding a component with a highest amplitude in the amplitude frequency data is considered to be the absolute value of the natural frequency difference; and
a fifth step: performing permutation and combination on blades on a bladed disk, repeating the second step to the fourth step to obtain absolute values of the natural frequency differences between all the blades, calculating a sum of the absolute values of the natural frequency differences between each blade and other blades, and considering that the natural frequency of the blade is abnormal when the sum of the absolute values of the natural frequency differences is greater than a predetermined threshold.

According to the method, in the first step, the single blade tip timing sensor acquires the actual arrival time t of the rotating blade with uniform acceleration or uniform deceleration, a difference between theoretical arrival time and actual arrival time is converted into a blade tip displacement according to the rotational speed fᵣ and the blade length R of the blade; and an expression is as follows: d(t_{i,j})=2πR·fᵣ^{j}·(t_{i,j}−t̅_{i,j}), where t̅_{i,j} represents the theoretical arrival time, d(t_{i,j}) represents the displacement of an i-th blade at a j-th turn at the time t_{i,j},

$${\overline{t}}_{i , j} = \frac{60 \cdot ( {θ}_{i} + {α}_{k} )}{2 π n} ,$$

where θᵢ represents an angle of the i-th blade based on a mounting position of a rotational speed sensor, αₖ represents an angle of a k-th sensor based on the mounting position of the rotational speed sensor, and n is the rotational speed.

In the method, the rotating process of the blade is an acceleration or deceleration process of a predetermined acceleration; and in the rotating process, gas nozzles distributed uniformly in a circumferential direction are used to simulate gas excitation.

In the method, for the two segments of displacement data vectors dᵢ, dⱼ of two blades at the same rotational speed, intercepted data intervals are both [c−N, c+N], a vector length is 2N+1, where c is an index serial number corresponding to a certain position in the displacement data of the two blades, dᵢ is a vector, the length is L, and a position of each element is an index serial number of each element, an index serial number of the first element is 1, and an index serial number of the last element is L.

In the method, a sampling frequency fₛ of the single sensor is approximate to an average rotational frequency,

$${f}_{s} \approx \frac{1}{2 N + 1} {\sum }_{k = 1}^{2 N + 1} {f}_{r}^{k} ,$$

where fᵣ^{k} represents a rotational speed at a k-th turn, and since the above intercepted data is data with the index serial number [c−N, c+N], the data from a (c−N)-th turn to a (c+N)-th turn is intercepted for the single sensor.

According to the method, in the fourth step, the filtered product vector dᵢⱼ^{lpf} is subjected to Hilbert transform to obtain a plural vector Hdᵢⱼ, the instantaneous phase is calculated by using a relationship between a real part and an imaginary part,

$${φ}_{ij} = arc tan \frac{Im ( {Hd}_{ij} )}{Re ( {Hd}_{ij} )} ,$$

where Im(Hdᵢⱼ) represents an imaginary part vector of the plural vector Hdᵢⱼ, and Re(Hdᵢⱼ) represents a real part vector of the plural vector Hdᵢⱼ.

According to the method, in the fourth step, the instantaneous phase φᵢⱼ is subjected to discrete Fourier transform to obtain spectrum data, an amplitude frequency diagram is drawn, and the natural frequency difference Dfᵢⱼ between the two blades is extracted from the amplitude frequency diagram,

$$X ( k ) = {\sum }_{n = 0}^{N - 1} x ( n ) cos ( \frac{2 π kn}{N} ) - i {\sum }_{n = 0}^{N - 1} x ( n ) sin ( \frac{2 π kn}{N} ) ,$$

where x(n) is a signal obtained by sampling, i is an imaginary number symbol, i=\sqrt{−1}, n is an iteration number, traversing is performed from 0 to N−1, that is, all elements in x are taken, k is an integer from 0 to N−1, and X(k) represents k-th data after discrete Fourier transform.

According to the method, in the fifth step, the blades on the bladed disk are combined in pairs to obtain Cₙ_{_{b}}² combinations, the second step to the fourth step are repeated to obtain Cₙ_{_{b}}² frequency differences, the sum of the absolute values of the natural frequency differences between each blade and other n_{b}−1 blades is calculated, determination is performed according to a set threshold HF, HF>0,

$${sumD}_{i} = {\sum }_{j = 1 , j \neq i}^{{n}_{b}} {Df}_{ij} ,$$

and the natural frequency of the blade is determined to be abnormal in the case of sumDₖ>HF.

According to the method provided by the present disclosure, the natural frequency differences between different blades can be extracted from the excessively undersampled data only by using the single blade tip timing sensor and without the rotational speed reference; furthermore, whether a fault is in the blade is determined according to the natural frequency differences between different blades without additional signal reconstruction and more blade tip timing sensors, so that the method is rapid and stable to operate, simple and feasible, and capable of detecting the natural frequency of the rotating blade, thereby detecting the fault of the blade on line.

The above description is merely an overview of the technical solution of the present disclosure. To make the technical means of the present disclosure more comprehensible to be implemented by those skilled in the art in accordance with the content of the description and to make the above and other objectives, features and advantages of the present disclosure more obvious and understandable, the specific implementations of the present disclosure are illustrated below.

### BRIEF DESCRIPTION OF THE DRAWINGS

Various advantages and benefits become apparent to those of ordinary skill in the art upon reading detailed description of the following preferred specific implementations. The accompanying drawings of the description are merely used to show the preferred implementations, and are not considered as limitations to the present disclosure. Apparently, the accompanying drawings described below are merely some embodiments of the present disclosure, and those of ordinary skill in the art may still derive other drawings from these accompanying drawings without creative efforts. In addition, in all of the accompanying drawings, the same parts are represented by the same reference numerals.

In the accompanying drawings:

FIG. 1 is a schematic diagram showing steps of a method for detecting a natural frequency of a blade by a single blade tip timing sensor;

FIG. 2 is testbed for identifying abnormity of a natural frequency of a blade by a single blade tip timing sensor with a rotational speed reference;

FIG. 3 is a time domain diagram of a product vector dᵢⱼ after dot product of intercepted displacement data of a blade 1 and a blade 2;

FIG. 4 is a time domain diagram of a signal dᵢⱼ^{lpf} after a product vector of a blade 1 and a blade 2 is subjected to low-pass filtering;

FIG. 5 is an instantaneous phase φᵢⱼ obtained by performing Hibert transform on a product vector of a blade 1 and a blade 2 subjected to low-pass filtering; and

FIG. 6 is a diagram showing an amplitude frequency after an instantaneous phase of a product vector of a blade 1 and a blade 2 is subjected to discrete Fourier transform.

The present disclosure is further described below with reference to the accompanying drawings and embodiments.

### DETAILED DESCRIPTION OF THE EMBODIMENTS

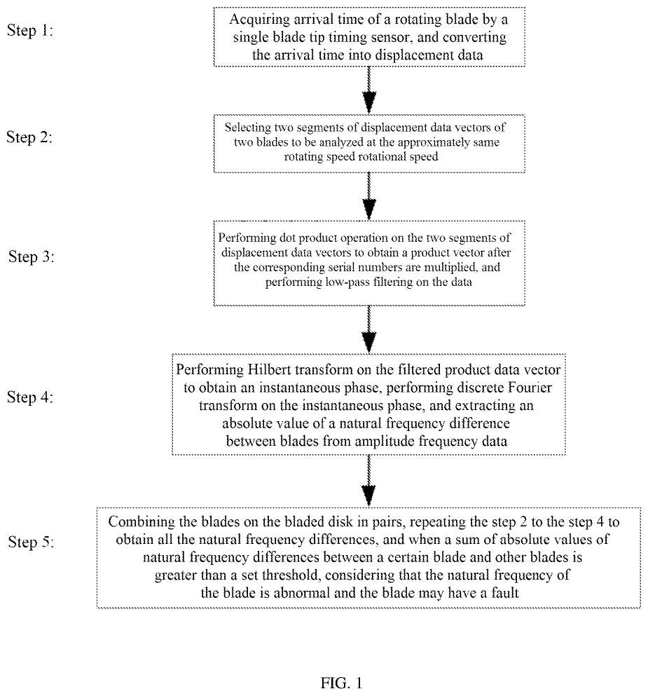

The specific embodiments of the present disclosure will be described in detail below with reference to FIG. 1 to FIG. 6. Although the accompanying drawings show the specific embodiments of the present disclosure, it should be understood that the present disclosure may be implemented in various forms and shall not be limited by the embodiments described herein. On the contrary, these embodiments are provided to provide a more thorough understanding of the present disclosure, and the scope of the present disclosure can be fully conveyed to those skilled in the art.

It should be noted that some terms are used in the description and the claims to refer to specific components. It should be understood by those skilled in the art that technicians may use different names to refer to the same component. The description and the claims do not use the difference in names as a way of distinguishing components, but use the difference in functions as a criterion for distinguishing the components. The word “comprise” or “include” as used throughout the description and claims is an open term and should be interpreted as “including but not limited to”. The subsequent description of the description is about preferred implementation of the present disclosure. However, the description is for the purpose of the general principle of the description, and is not intended to limit the scope of the present disclosure. The protection scope of the present disclosure is defined by the appended claims.

In order to facilitate the understanding of the embodiments of the present disclosure, the specific embodiments will be taken as examples for further explanation and description in combination with the accompanying drawings, and the drawings do not constitute a limitation to the embodiments of the present disclosure.

A method for detecting a natural frequency of a blade by a single blade tip timing sensor includes the following steps.

(1) Arrival time and a rotational speed of a rotating blade are acquired by a blade tip timing sensor, and a difference between theoretical arrival time and actual arrival time is converted into a blade tip displacement according to the rotational speed and a blade length.

In this exemplary example, specifically, a single optical fiber blade tip timing sensor is fixed on a casing, an initial rotational speed is set to 60 Hz, an acceleration of the rotational speed is set to 0.5 Hz/s, and a change range of the rotational speed is 60 Hz-100 Hz-60 Hz, wherein the time for the 100 Hz constant speed segment is 20 seconds. A bladed disk adopts a six-blade integrated aluminum alloy bladed disk, wherein the radius of the bladed disk is R=68 mm, the thickness of the blade is d=1 mm, and the width of the blade is w=20 mm. Four nozzles are uniformly distributed on the casing to spray 0.5 Mpa high-pressure gas. The arrival time of the rotating blade is acquired by a single blade tip timing sensor, a rotational speed of a rotating shaft is acquired by a rotational speed sensor, and the difference between the theoretical arrival time and the actual arrival time is converted into the blade tip displacement according to the rotational speed and the blade length.

(2) Two segments of displacement data vectors of two blades to be analyzed at the approximately same rotational speed are selected. If slow acceleration or deceleration data is selected, the intercepted data is inadvisable to be too long, so as to meet the requirement of an approximately constant sampling frequency is met.

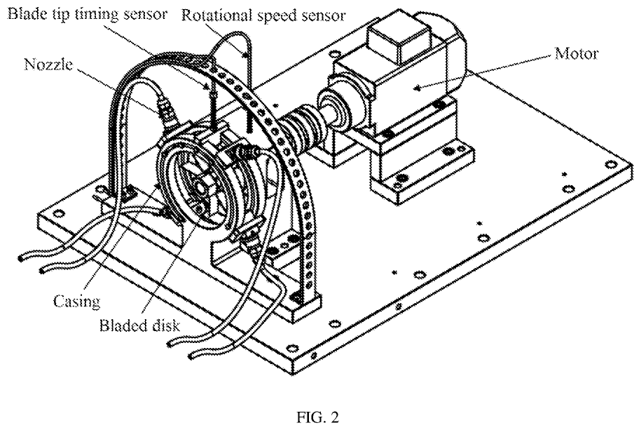

In this exemplary example, specifically, displacement data of a blade 1 and a blade 2 is selected, and a serial number range of the intercepted data is [4840,4970]. As shown in FIG. 2, a change range of a corresponding rotational speed estimated by the blade tip timing sensor is: 85.15 Hz˜85.77 Hz, and an approximately sampling frequency fₛ=85.46 Hz.

(3) The two displacement data vectors are subjected to dot product operation to obtain a product vector after the corresponding serial numbers are multiplied, and the data is subjected to low-pass filtering.

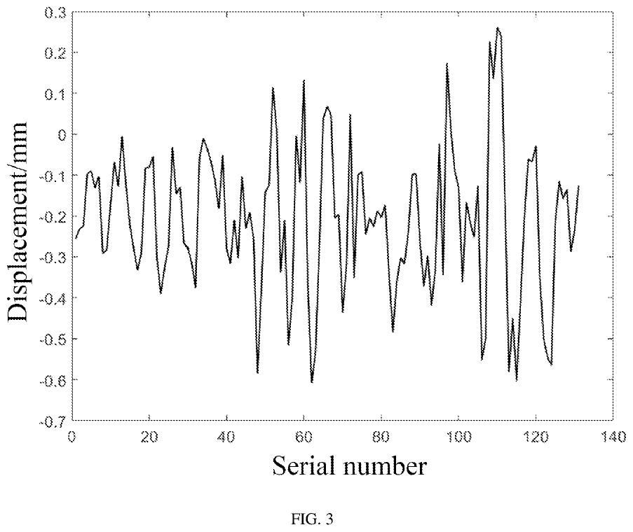

In this exemplary example, the intercepted displacement vectors of the blade 1 and the blade 2 are d₁ and d₂. The intercepted two vectors d₁ and d₂ are multiplied to obtain a product vector d₁₂ of the blade 1 and the blade 2, as shown in FIG. 3.

d₁₂=d₁d₂^{T} (7)

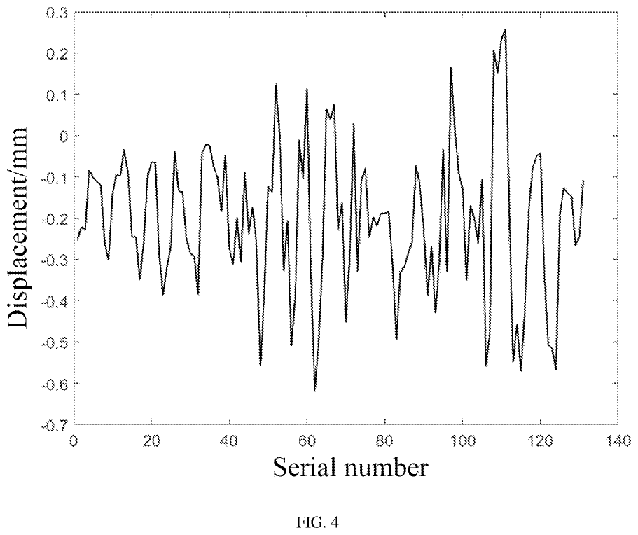

According to the prior knowledge of the natural frequency of the blade, the absolute value of the natural frequency difference between the blades does not exceed 40 Hz at most. Therefore, 40 Hz is selected to be a cutoff frequency for low-pass filtering of the product vector d₁₂ to obtain d₁₂^{lpf}, as shown in FIG. 4.

(4) The filtered product vector is subjected to Hilbert transform to obtain an instantaneous phase, the instantaneous phase is subjected to discrete Fourier transform, and an absolute value of a natural frequency difference between blades is extracted from amplitude frequency data.

In this exemplary example, the product vector is subjected to Hilbert transform to obtain a plural vector, and an expression is as follows:

$${Hd}_{12} ( n ) = {d}_{12}^{lpf} ( n ) + j {\sum }_{k = - ∞}^{+ ∞} \frac{1}{π ( n - k )} {d}_{12}^{lpf} ( n ) = Re ( {Hd}_{12} ) + Im ( {Hd}_{12} ) \qquad ( 8 )$$

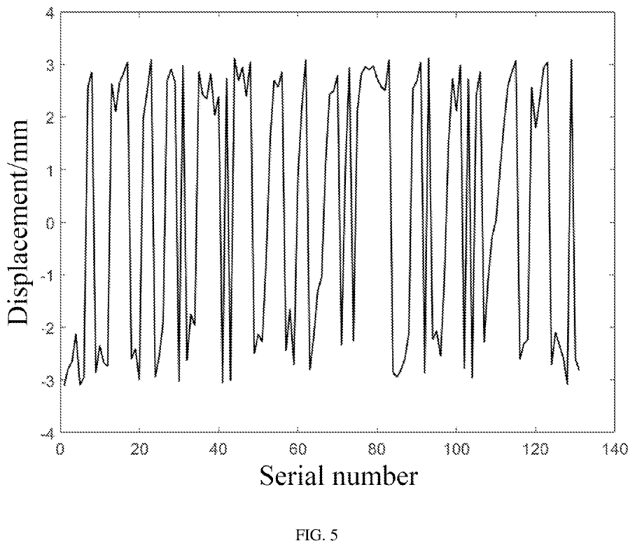

The instantaneous phase φ₁₂ is calculated according to Hd₁₂, as shown in FIG. 5, and an expression is as follows:

$${φ}_{12} = arc tan \frac{Im ( {Hd}_{12} )}{Re ( {Hd}_{12} )} \qquad ( 9 )$$

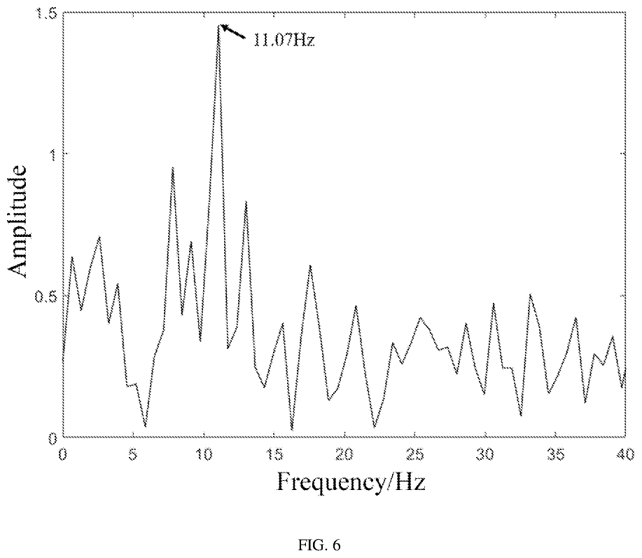

The instantaneous phase is subjected to discrete Fourier transform, and an absolute value of a natural frequency difference between the blade 1 and the blade 2 is extracted from amplitude frequency data, as shown in FIG. 6.

(5) Blades on a bladed disk are subjected to permutation and combination, the steps (2) to (4) are repeated to obtain absolute values of natural frequency differences of all blades, a sum of the absolute values of the natural frequency differences between each blade and other blades is calculated, and when the sum of the absolute values of the natural frequency differences of a certain blade is greater than a set threshold, it is considered that the natural frequency of the blade is abnormal and the blade may have a fault.

In this exemplary example, the bladed disk with six blades is adopted, so n_{b}=6, and it is necessary to calculate C₆² frequency differences, and the obtained natural frequency differences of all the combined blades are shown in the following table:

| | Frequency Difference Dfᵢⱼ/Hz | | | | | |
|---|---|---|---|---|---|---|
| | Blade 1 | Blade 2 | Blade 3 | Blade 4 | Blade 5 | Blade 6 |
| Blade 1 | 0 | 11.07 | 19.2 | 12.8 | 0 | 7.4 |
| Blade 2 | — | 0 | 7.7 | 0 | 11.7 | 1.1 |
| Blade 3 | — | — | 0 | 6.6 | 20.2 | 7.7 |
| Blade 4 | — | — | — | 0 | 12.7 | 2.2 |
| Blade 5 | — | — | — | — | 0 | 8.4 |
| Blade 6 | — | — | — | — | — | 0 |

Actually, it is only necessary to calculate 15 groups of blade difference frequencies. According to the above 15 groups of difference frequencies, the sum sumDᵢ of the absolute values of the natural frequency differences between each blade and other five blades may be calculated.

| | Blade 1 | Blade 2 | Blade 3 | Blade 4 | Blade 5 | Blade 6 |
|---|---|---|---|---|---|---|
| sumDᵢ | 50.47 Hz | 32.2 Hz | 61.4 Hz | 34.3 Hz | 53 Hz | 26.8 Hz |

A threshold HF=50 Hz is selected, which shows that sumD₁, sumD₃, sumD₅ exceed the set threshold HF, so that it is presumed that the natural frequencies of the blade 1, the blade 3 and the blade 5 are abnormal.

The natural frequency of the rotating blade is identified by a strain gauge and an electrically conductive slip ring, and the obtained results are shown in the following table:

TABLE 1
The natural frequency of the blade obtained
by the strain gauge measurement method

| | Serial Number of Blades | | | | | |
|---|---|---|---|---|---|---|
| | Blade 1 | Blade 2 | Blade 3 | Blade 4 | Blade 5 | Blade 6 |
| Natural | 341.95 | 354.32 | 364.29 | 354.02 | 341.97 | 351.53 |
| frequency/Hz | | | | | | |

It is known that the normal natural frequencies of the blades of the bladed disk are about 350 Hz, wherein the natural frequencies of the blade 1, the blade 3 and the blade 5 are quite different from 350 Hz. Actually, the roots of the blade 1 and the blade 5 on the bladed disk have tiny cracks, and the natural frequency of the blade 3 is higher due to a machining error. Therefore, by the method provided by the present disclosure, the abnormity of the natural frequency of the blade can be identified by the signal of the single blade tip timing sensor. According to the present disclosure, the absolute values of the natural frequency differences between different blades can be extracted from the excessively undersampled data only by the single blade tip timing sensor; furthermore, the sum of the absolute values of the natural frequency differences between each blade and other blades is calculated, whether the natural frequency of the blade is abnormal is determined according to the set threshold HF, thereby determining whether the blade is in fault. According to the method of the present disclosure, additional signal reconstruction and more blade tip timing sensors are not required, the identification system is simple, operation is rapid and stable, simplicity and feasibility are achieved, and real-time health monitoring of the rotating blade can be realized.

### Application Example

On a blade tip timing sensor testbed as shown in FIG. 2, a single optical fiber blade tip timing sensor is fixed on a casing, an initial rotational speed is set to 60 Hz, an acceleration of a rotational speed is set to 0.5 Hz/s, and a change range of the rotational speed is 60 Hz-100 Hz-60 Hz, wherein the time for the 100 Hz constant speed segment is 20 seconds. A bladed disk adopts a six-blade integrated aluminum alloy bladed disk, wherein the radius of the bladed disk is R=68 mm, the thickness of the blade is d=1 mm, and the width of the bladed is w=20 mm. Four nozzles are uniformly distributed on the casing to spray 0.5 Mpa high-pressure gas. The arrival time of the rotating blade is acquired by a single blade tip timing sensor, a rotational speed of a rotating shaft is acquired by a rotational speed sensor, and a difference between theoretical arrival time and actual arrival time is converted into a blade tip displacement according to the rotational speed and the blade length.

Displacement data of a blade 1 and a blade 2 is selected, and the serial number range of the intercepted data is [4840,4970]. As shown in FIG. 2, the change range of the corresponding rotational speed estimated by the blade tip timing sensor is: 85.15 Hz˜85.77 Hz, and the approximately sampling frequency fₛ=85.46 Hz.

The intercepted displacement vectors of the blade 1 and the blade 2 are d₁ and d₂. The intercepted two vectors d₁ and d₂ are multiplied to obtain a product vector d₁₂ of the blade 1 and the blade 2, as shown in FIG. 3.

d₁₂=d₁d₂^{T} (10)

According to the prior knowledge of the natural frequency of the blade, the absolute value of the natural frequency difference between the blades does not exceed 40 Hz at most. Therefore, 40 Hz is selected to be a cutoff frequency for low-pass filtering of the product vector d₁₂ to obtain d₁₂^{lpf}, as shown in FIG. 4.

The product vector d₁₂^{lpf} is subjected to Hilbert transform to obtain a plural vector, and an expression is as follows:

$${Hd}_{12} ( n ) = {d}_{12}^{lpf} ( n ) + j {\sum }_{k = - ∞}^{+ ∞} \frac{1}{π ( n - k )} {d}_{12}^{lpf} ( n ) = Re ( {Hd}_{12} ) + Im ( {Hd}_{12} ) \qquad ( 11 )$$

The instantaneous phase φ₁₂ is calculated according to Hd₁₂, as shown in FIG. 5, and an expression is as follows:

$${φ}_{12} = arc tan \frac{Im ( {Hd}_{12} )}{Re ( {Hd}_{12} )} \qquad ( 12 )$$

The instantaneous phase is subjected to discrete Fourier transform, and an absolute value of a natural frequency difference between the blade 1 and the blade 2 is extracted from amplitude frequency data, as shown in FIG. 6.

In this example, the bladed disk with six blades is adopted, so n_{b}=6, and it is necessary to calculate C₆² frequency differences, and the obtained natural frequency differences of all the combined blades are shown in the following table:

| | Frequency Difference Dfᵢⱼ/Hz | | | | | |
|---|---|---|---|---|---|---|
| | Blade 1 | Blade 2 | Blade 3 | Blade 4 | Blade 5 | Blade 6 |
| Blade 1 | 0 | 11.7 | 19.2 | 12.8 | 0 | 7.4 |
| Blade 2 | — | 0 | 7.7 | 0 | 11.7 | 1.1 |
| Blade 3 | — | — | 0 | 6.6 | 20.2 | 7.7 |
| Blade 4 | — | — | — | 0 | 12.7 | 2.2 |
| Blade 5 | — | — | — | — | 0 | 8.4 |
| Blade 6 | — | — | — | — | — | 0 |

Actually, it is only necessary to calculate 15 groups of blade difference frequencies. According to the above 15 groups of difference frequencies, the sum sumDᵢ of the absolute values of the natural frequency differences between each blade and other five blades may be calculated.

| | Blade 1 | Blade 2 | Blade 3 | Blade 4 | Blade 5 | Blade 6 |
|---|---|---|---|---|---|---|
| sum Dᵢ | 51.1 Hz | 32.2 Hz | 61.4 Hz | 34.3 Hz | 53 Hz | 26.8 Hz |

A threshold HF=50 Hz is selected, which shows that sumD₁, sumD₃, sumD₅ exceed the set threshold HF, so that it is presumed that the natural frequencies of the blade 1, the blade 3 and the blade 5 are abnormal.

The natural frequency of the rotating blade is identified by a strain gauge and an electrically conductive slip ring, and the obtained results are:

TABLE 1
The natural frequency of the blade obtained
by the strain gauge measurement method

| | Serial Number of Blades | | | | | |
|---|---|---|---|---|---|---|
| | Blade 1 | Blade 2 | Blade 3 | Blade 4 | Blade 5 | Blade 6 |
| Natural | 341.95 | 354.32 | 364.29 | 354.02 | 341.97 | 351.53 |
| frequency/Hz | | | | | | |

It is known that the normal natural frequencies of the blades of the bladed disk are about 350 Hz, wherein the natural frequencies of the blade 1, the blade 3 and the blade 5 are quite different from 350 Hz. Actually, the roots of the blade 1 and the blade 5 on the bladed disk have tiny cracks, and the natural frequency of the blade 3 is higher due to a machining error. Therefore, by the method provided by the present disclosure, the abnormity of the natural frequency of the blade can be identified by the signal of the single blade tip timing sensor. According to the present disclosure, the absolute values of the natural frequency differences between different blades can be extracted from the excessively under sampled data only by the single blade tip timing sensor; furthermore, the sum of the absolute values of the natural frequency differences between each blade and other blades is calculated, whether the natural frequency of the blade is abnormal is determined according to the set threshold HF, thereby determining whether the blade is in fault. According to the method of the present disclosure, additional signal reconstruction and more blade tip timing sensors are not required, the identification system is simple, operation is rapid and stable, simplicity and feasibility are achieved, and real-time health monitoring of the rotating blade can be realized.

Although the embodiments of the present disclosure are described above in combination with the accompanying drawings, the present disclosure is not limited to the above specific embodiments and application field, and the above specific embodiments are only illustrative and instructive, rather than being restrictive. Those of ordinary skills in the art can make various forms under the inspiration of this description and without departing from the protection scope of the claims of the present disclosure, which all fall within the protection scope of the present disclosure.

What is claimed is:

1. A method for detecting a natural frequency of a blade by a single blade tip timing sensor, comprising the following steps:
a first step (S1): acquiring actual arrival time of a rotating blade by using a single blade tip timing sensor, and converting a difference between theoretical arrival time and the actual arrival time into displacement data of a blade tip according to a rotational speed and a blade length of the rotating blade;
a second step (S2): intercepting two segments of displacement data vectors of two blades at the same rotational speed from the displacement data;
a third step (S3): performing dot product on the two segments of displacement data vectors to obtain a product data vector, and performing low-frequency filtering on the product data vector;
a fourth step (S4): performing Hilbert transform on the filtered product vector to obtain an instantaneous phase, performing discrete Fourier transform on the instantaneous phase, and extracting an absolute value of a natural frequency difference between blades from amplitude frequency data, wherein a frequency corresponding a component with a highest amplitude in the amplitude frequency data is considered to be the absolute value of the natural frequency difference; and
a fifth step (S5): performing permutation and combination on blades on a bladed disk, repeating the second step to the fourth step to obtain absolute values of the natural frequency differences between all the blades, calculating a sum of the absolute values of the natural frequency differences between each blade and other blades, and considering that the natural frequency of the blade is abnormal when the sum of the absolute values of the natural frequency differences is greater than a predetermined threshold.

2. The method according to claim 1, wherein in the first step (S1), the single blade tip timing sensor acquires the actual arrival time t of the rotating blade with uniform acceleration or uniform deceleration, a difference between theoretical arrival time and actual arrival time is converted into a blade tip displacement according to the rotational speed fᵣ and the blade length R of the blade; and an expression is as follows: d(t_{i,j})=2πR·fᵣ^{j}·(t_{i,j}−t̅_{i,j}), where t̅_{i,j} represents the theoretical arrival time, d(t_{i,j}) represents the displacement of an i-th blade at a j-th turn at the time t_{i,j},
$${\overline{t}}_{i , j} = \frac{60 \cdot ( {θ}_{i} + {α}_{k} )}{2 π n} ,$$
where θᵢ represents an angle of the i-th blade based on amounting position of a rotational speed sensor, αₖ represents an angle of a k-th sensor based on the mounting position of the rotational speed sensor, and n is the rotational speed.

3. The method according to claim 2, wherein the rotating process of the blade is an acceleration or deceleration process of a predetermined acceleration; and in the rotating process, gas nozzles distributed uniformly in a circumferential direction are used to simulate gas excitation.

4. The method according to claim 1, wherein for the two segments of displacement data vectors dᵢ, dⱼ of two blade sat the same rotational speed, intercepted data intervals are both [c−N, c+N], a vector length is 2N+1, where c is an index serial number corresponding to a certain position in the displacement data of the two blades, dᵢ is a vector, the length is L, and a position of each element is an index serial number of each element.

5. The method according to claim 1, wherein a sampling frequency fₛ of the single sensor is approximate to an average rotational frequency,
$${f}_{s} \approx \frac{1}{2 N + 1} {\sum }_{k = c - N}^{c + N} {f}_{r}^{k} ,$$
where fᵣ^{k} represents a rotational speed at a k-th turn, and since the above intercepted data is data with the index serial number [c−N, c+N], the data from a (c−N)-th turn to a (c+N)-th turn is intercepted for the single sensor.

6. The method according to claim 1, wherein in the fourth step (S4), the filtered product vector dᵢⱼ^{lpf} is subjected to Hilbert transform to obtain a plural vector Hdᵢⱼ, the instantaneous phase is calculated by using a relationship between a real part and an imaginary part,
$${φ}_{ij} = arc tan \frac{Im ( {Hd}_{ij} )}{Re ( {Hd}_{ij} )} ,$$
where Im(Hdᵢⱼ) represents an imaginary part vector of the plural vector Hdᵢⱼ, and Re(Hdᵢⱼ) represents a real part vector of the plural vector Hdᵢⱼ.

7. The method according to claim 6, wherein in the fourth step (S4), the instantaneous phase φᵢⱼ is subjected to discrete Fourier transform to obtain spectrum data, an amplitude frequency diagram is drawn, and the natural frequency difference Dfᵢⱼ between the two blades is extracted from the amplitude frequency diagram,
$$X ( k ) = {\sum }_{n = 0}^{N - 1} x ( n ) cos ( \frac{2 π kn}{N} ) - i {\sum }_{n = 0}^{N - 1} x ( n ) sin ( \frac{2 π kn}{N} ) ,$$
where x(n) is a signal obtained by sampling, i is an imaginary number symbol, i=\sqrt{−1}, n is an iteration number, traversing is performed from 0 to N−1, that is, all elements in x are taken, k is an integer from 0 to N−1, and X(k) represents k-th data after discrete Fourier transform.

8. The method according to claim 1, wherein in the fifth step (S5), the blades on the bladed disk are combined in pairs to obtain Cₙ_{_{b}}² combinations, the second step to the fourth step are repeated to obtain Cₙ_{_{b}}² frequency differences, the sum of the absolute values of the natural frequency differences between each blade and other n_{b}−1 blades is calculated, determination is performed according to a set threshold HF, HF>0,
$${sumD}_{i} = {\sum }_{j = 1 , j \neq i}^{{n}_{b}} {Df}_{ij} ,$$
and the natural frequency of the blade is determined to be abnormal in the case of sumDₖ>HF.
